(19) United States
(12) Patent Application Publication
(10) Pub. No.: US 2018/0098498 A1
(43) Pub. Date: Apr. 12, 2018

(54) Ergonomic Harvesting Bag

(71) Applicant: Brian Richie Designs Incorporated, Newport Beach, CA (US)

(72) Inventor: Brian Ritchie, Laguna Beach, CA (US)

(21) Appl. No.: 15/726,830

(22) Filed: Oct. 6, 2017

Related U.S. Application Data
(60) Provisional application No. 62/405,173, filed on Oct. 6, 2016.

(51) Int. Cl. A01D 46/22

(52) U.S. Cl. CPC A01D 46/22; A01D 45/00

(57) ABSTRACT

An ergonomic harvesting bag is provided for attachment to a user's body via an adjustable strap around the waist and/or neck. It allows the user to comfortably trim in a reclined or standing position. The advantage of using the ergonomic harvesting bag is that the user does not need to reach with their arms or body to approach the work, or perform the task of trimming over a table or receptacle, or on the lap or floor because the receptacle is attached and close to the body. The ergonomic harvesting bag includes an upper section, a lower section, an opening and a cavity within which items of interest may be inserted, the adjustable strap coupled to the upper section of the harvesting bag and a filter mechanism removably positioned within the cavity of the harvesting bag.

### BACKGROUND OF THE INVENTION

### 1. Field of the Invention

The present invention relates to bags used to retain harvested plants. More particularly, the present invention relates to bags configured to reduce strain on the user over an extended period of time of harvesting.

### 2. Description of the Prior Art

When a person harvests and processes agricultural products including, but not limited to, cannabis, they often trim the product such as with scissors, and collect the trimmings in a receptacle of some kind. The receptacle may also be used to retain other harvested items and byproducts, such as seeds, for example. Unfortunately, existing harvesting receptacles, which may simply be bags, increase the physical stress on the user, particularly when harvesting is conducted over an extended period of time.

The shortcomings of current methods used to collect trimmings and other byproducts of agricultural products are as follows. First, receptacles come in many shapes and sizes, and usually have the disadvantage of being fixed and distanced from the user's body to various degrees. This forces the user to accommodate their physical working relationship to the receptacle or tray or box or table, whether placed on the floor, or lap, or table surface. Usually, this resembles a forward-leaning or reaching with the arms and body, creating high risk postures. Users that put a tray or bin style receptacle on their lap to get it closer to the body still ending up reaching away from their bodies, especially when they are in a reclined posture, because in order for the trimmings to fall in the direction of gravity and land inside of the receptacle, reaching of the arms and static muscle load will cause discomfort and fatigue and, over time, could lead to injury. All of those results work negatively against productivity and efficiency.

In addition, there is no product that has an incorporated bib to protect clothing while reclining in a comfortable and supported posture. When the user is reclining, optimal positioning of the hands to trim or manicure or process the plant product is between the waist and chest, depending on vision acuity and other factors. As gravity directs trimmings downward, traditional methods of collection cannot be well positioned to receive the trimmings, and therefore, are largely ineffective with trimmings would land on the user's body or otherwise outside of the receptacle. The only option in that arrangement is for the user to sit forward over the tray or extend their arms to reach for the tray, both of which are risk factors for discomfort, fatigue and injury.

Further, the ability to go from a sitting to a standing position without touching such a harvesting receptacle, particularly a harvesting bag, which may be attached to the user, is desirable and more natural because it is an intuitive motion, rather than a conscious effort to pause and physically reposition the receptacle. What is needed is a harvesting receptacle or bag that is configured with desirable ergonomic configuration.

### SUMMARY OF THE INVENTION

The present invention is a harvesting bag with an ergonomic configuration. The ergonomic harvest bag of the present invention is a receptacle used for collecting trimmings and/or other byproducts from agricultural processing, and can be used in a sitting or standing position. The product concept was drawn from parallel study of computer users in a corporate or medical setting, where prolonged computer use was shown to cause discomfort and lead to injury if left unchecked. The present invention allows for improved seating posture while conducting such harvesting activities, including for the trimming of cannabis but not limited thereto. It also allows the user to work from a standing position, or switch from sitting to standing and vice versa. Studies have shown that the best seated posture is a reclined posture, to properly support the spine and reduce “static load.”

The ergonomic harvesting bag of the present invention is arranged for attachment to a user's body via an adjustable strap around the waist or neck. It allows the user to comfortably trim in a reclined or standing positon. The advantage of using the ergonomic harvesting bag is that the user does not need to reach with their arms or body to approach the work, or perform the task of trimming over a table or receptacle, or on the lap or floor because the receptacle is attached and close to the body. An additional optional component of the present invention is a separate secondary receptacle attached at the bottom of the bag. A screen liner or similar system of filtration within the primary receptacle bag or as a floor thereof allows small particles like cannabis trichomes or seeds, for example, to pass through, and collect in the attached secondary receptacle. Other options to facilitate collection with at least some preliminary filtering instead of or in addition to a mesh liner or screen, include a plastic liner, an internal collection cup and a zipper for removal of filtered particles.

The present invention allows the user to collect trimmings, seeds and other byproducts of processing agricultural products, while having the ability to do so in an ergonomic posture, whether sitting or standing. In addition, items collected in the bag have the ability to be filtered with a filter mechanism such as a mesh liner or screen, allowing for easy retention and removal of byproducts of the harvesting process.

The ergonomic harvesting bag of the present invention may also include an optional lid. The user, who may or may not be in a standing position, can work and harvest and trim outdoors, with the protection of a lid if it begins to rain, or if the user wants to protect from spillage of the bag. While working outdoors, in a standing position, the user can wear an additional trimming bag to use as storage of the already processed product, perhaps off to the side on their hip. The other hip would host such a separate utility bag/holster.

The ergonomic harvesting bag includes a harvesting bag having an upper section, a lower section, an opening and a cavity within which items of interest may be inserted, an adjustable strap coupled to the upper section of the harvesting bag and arranged for removable placement about a neck of a user to retain the harvesting bag adjacent to the user's waist, and a filter mechanism removably positioned within the cavity of the harvesting bag. The filter mechanism may be a mesh insert. The bag may include a bib or lid coupled to the upper section of the bag. It may include a waist strap coupled to the upper section of the harvesting bag and arranged for placement about the waist of the user. The bag may also include a removable secondary container coupled to the lower section of the harvesting bag. Further, a utility container may be coupled directly or indirectly to the harvesting bag. One or more utility pockets may be attached to the harvesting bag. The harvesting bag may optionally include a mesh screen positioned under the lower section of the harvesting bag.

The ergonomic harvesting bag of the present invention reduces the strain on the user who can thereby extend the harvesting period with reduced strain on the body. The additional components further optimize the harvesting process through the filtration of separable materials, an optional lid and an optional secondary retaining bag. These and other advantages of the invention will become apparent to those of skill in the art upon review of the accompanying drawings, detailed description and appended claims.

### BRIEF DESCRIPTION OF THE DRAWINGS

FIG. 1 is simplified front view of the ergonomic harvesting bag of the present invention positioned on a user.

FIG. 2 is a simplified front view of an interior liner of the ergonomic harvesting bag.

FIG. 3 is a simplified front view of the mesh insert of the ergonomic harvesting bag.

FIG. 4 is a simplified front view of the ergonomic harvesting bag without adjustable strap.

FIG. 5 is a simplified front view of the ergonomic harvesting bag with the adjustable strap and an optional supplemental utility bag and pockets.

FIG. 6 is a close-up perspective view of a zip tie that may be used with the ergonomic harvesting bag.

### DETAILED DESCRIPTION OF THE INVENTION

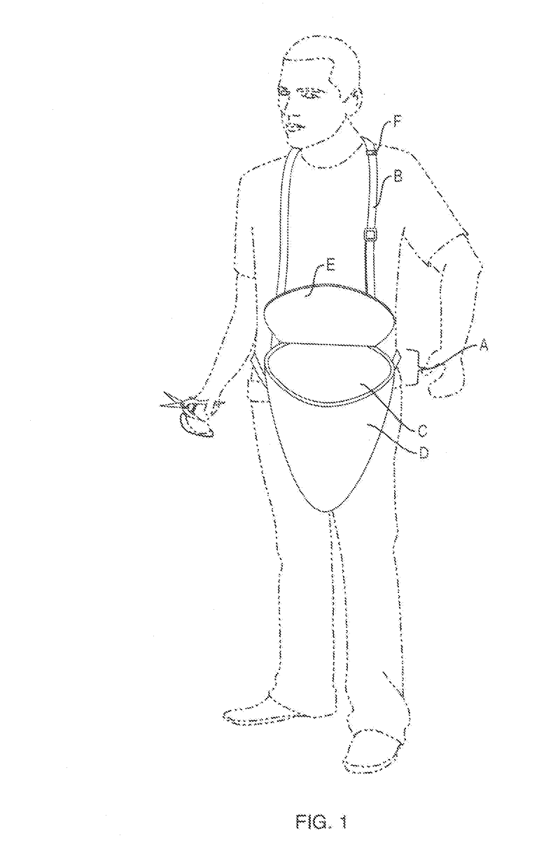

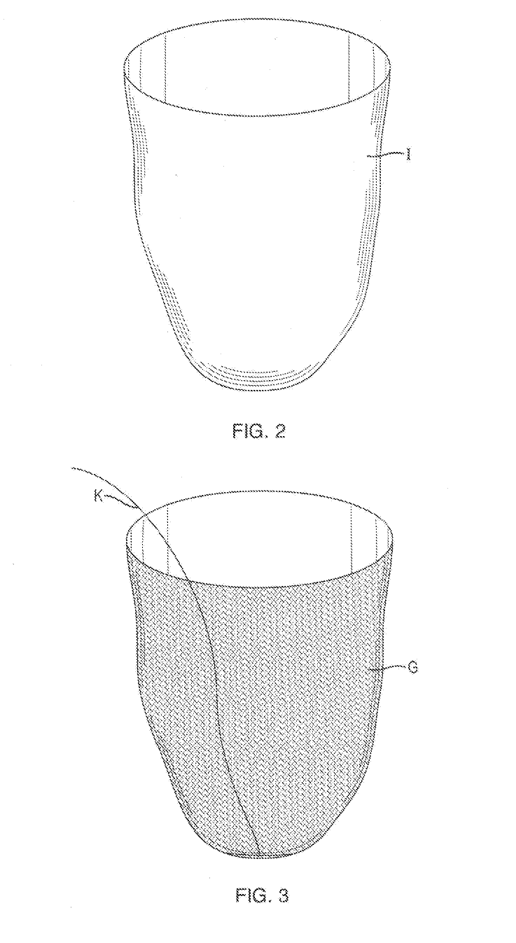

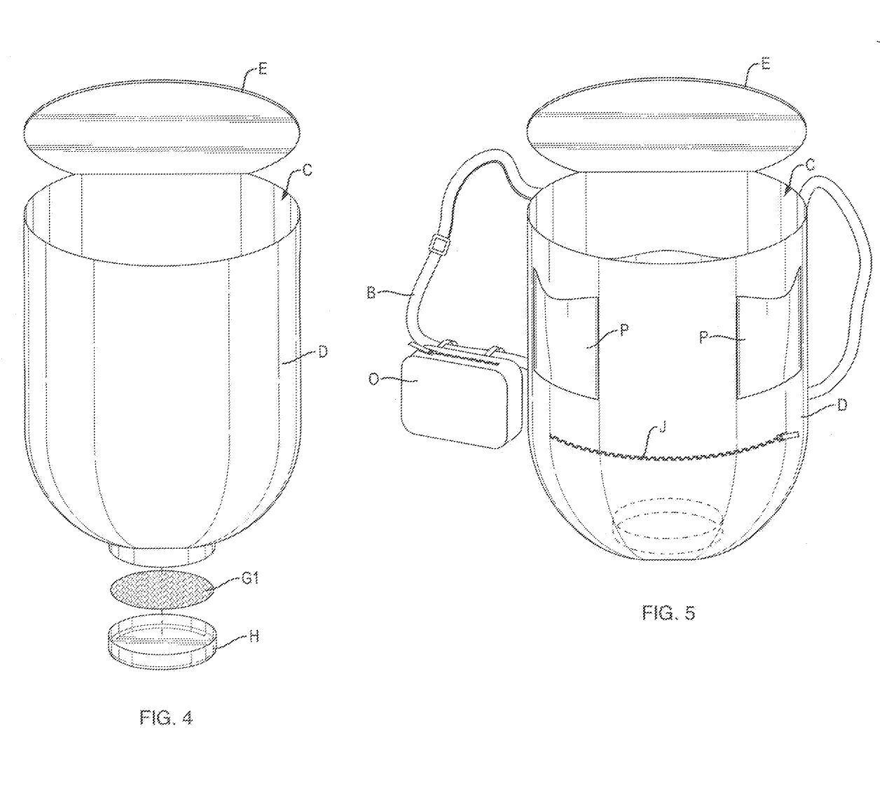

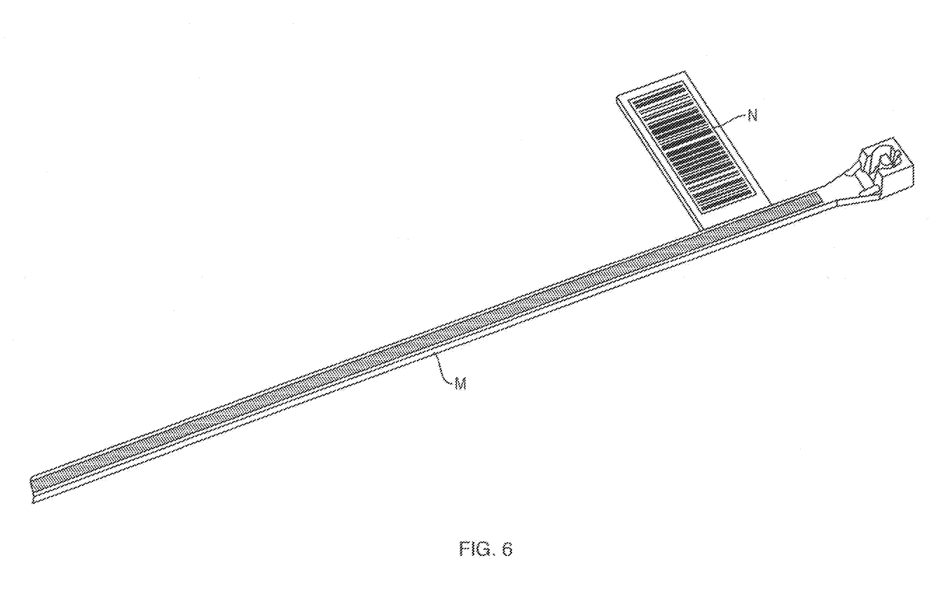

An ergonomic harvesting bag (D) of the present invention is shown in FIGS. 1-6. The ergonomic harvesting bag is a receptacle used to collect among other things, the trimmings and seeds of agricultural produce, such as cannabis, but not limited thereto. Specifically, when a person uses a scissors or other device to trim leaves and remove other byproducts, the present invention is used to catch and collect those items. The ergonomic harvesting bag is used in the following way. It is worn around the waist or body or neck, attaching to the front of the body and orienting an opening (C) of the bag at a comfortable, waist area height (A.) An adjustable strap and buckle or clip or loop attaches the trimming bag to the user's body (B). In order to direct the trimmings into the opening (C), to be collected in the bag (D), a bib (E) may be incorporated with the upper area of the bag to prevent trimmings from missing the bag and ending up on the user's clothing and the bib can provide the added utility as a closable lid. The lid can be zippered shut, or locked, or otherwise sealed. The bib may have a neck strap (F) or other mechanism to attach itself to the body or clothing to keep it in place.

A screen, mesh material or other insert with filtering qualities (G, G1) can be inserted into the empty bag in a nesting fashion, and filter out small particles such as cannabis trichomes or seeds. These small particles can be collected in a removable container, by gluing or otherwise attaching the threaded lid of a container to an opening in the bag to which a supplemental container may be permanently or removably affixed. A nonmetallic container may be used for that purpose. The threaded lid may include a port thereof arranged to allow filtered harvested material to pass through into the container. A removable or fixed container (H) can also be inserted into the bottom of the bag for collection purposes. Alternatively, the harvested material may be collected in a plastic liner (I) or simply in the bottom of the bag. A zipper or Velcro coupling (J) may be incorporated to access contents in the bottom of the bag. To facilitate the filtering process by tossing the mesh liner's contents, a string (K) may be attached to the bottom of the insert to be pulled up and down, for example.

The ergonomic harvesting bag offers bio-mechanic and other ergonomic and efficiency advantages over other devices and methods of collecting trimmings and byproducts of agricultural produce. Traditional methods typically rely on a freestanding receptacle, such as a box or bin or tray or bag, or a table top. Due to their fixed physical relationship to the user, traditional receptacles or surfaces often cause the user to assume a forward leaning or reaching posture, causing a misalignment of pressure points in the spine, and often augmented by static load and unsupported spine curvature and body weight. These types of postures are shown through study to lead to discomfort, pain and can develop into a diagnosable musculoskeletal disorder; especially when maintained over long periods of time. Conversely, studies show that a reclined, supported body posture is the best posture to maintain while performing a task that allows for such reclined posture. The specific, tedious and unchanging nature of trimming/manicuring cannabis for instance, allows for a reclined or standing posture (or intermittent sitting/standing, recommended) which leads to prolonged comfort and reduces risk of injury and related inefficiencies.

The present invention enables effective harvesting while putting the user in these preferred postures due to the present bag's opening being optimally positioned, close and attached to the body, with a bib to direct trimmings into the bag opening and protect the user's clothing from the trimmings or other byproduct, especially in a reclined posture. In a standing posture, when the bib, which may be removably attached to the bag, is considered to be unnecessary, it can be removed as desired. The bag may also be configured without a bib or lid at all. In cases where the user is inclined or required to hold to strict security and accountability of the contents of the plastic bag liner (I), a security mechanism can be used to securely close and lock the opening, using a mechanism commonly referred to as a “zip tie” (one way, non-reversible, unless destroyed or removed from function). The “zip tie mechanism” (M) includes an incorporated area to accommodate a label or bar code (N) toward identification and details regarding the contents within the bag.

An optional smaller utility bag with compartments (O), or similar holster to hold things like scissors, tools, a phone etc., may be removably attached to the same belt that holds the main bag to the waist. Such a utility bag provides easy access to tools selectively retained therein to improve efficiency and easy reach. The main body of the bag may have strategically located pockets (P) for a variety of storage uses.

The ergonomic harvesting bag of the present invention can be used to collect and/or carry any number of items, whether of a horticultural nature, such as seed filtration and collection, or other non-horticultural items, such as gathered art materials, for example. The invention is not limited thereto and covers reasonable equivalents in view of the following appended claims.

What is claimed is:

1. An ergonomic harvesting bag comprising:
a. a harvesting bag having an upper section, a lower section, an opening and a cavity within which items of interest may be inserted;
b. an adjustable strap coupled to the upper section of the harvesting bag and arranged for removable placement about a neck of a user to retain the harvesting bag adjacent to the user's waist; and
c. a filter mechanism removably positioned within the cavity of the harvesting bag.

2. The ergonomic harvesting bag of claim 1 further comprising a bib or lid coupled to the upper section of the bag.

3. The ergonomic harvesting bag of claim 1 further comprising a waist strap coupled to the upper section of the harvesting bag and arranged for placement about the waist of the user.

4. The ergonomic harvesting bag of claim 1 further comprising a removable secondary container coupled to the lower section of the harvesting bag.

5. The ergonomic harvesting bag of claim 1 further comprising a utility container directly or indirectly coupled to the harvesting bag.

6. The ergonomic harvesting bag of claim 1 further comprising one or more utility pockets coupled to the harvesting bag.

7. The ergonomic harvesting bag of claim 1 further comprising a mesh screen positioned under the lower section of the harvesting bag.

8. The ergonomic harvesting bag of claim 1 wherein the filtering mechanism is a mesh insert.
